(19) United States
(12) Patent Application Publication
(10) Pub. No.: US 2016/0299566 A1
(43) Pub. Date: Oct. 13, 2016

(54) RETRIEVING FOCUS-BASED INFORMATION

(71) Applicant: International Business Machines Corporation, Armonk, NY (US)

(72) Inventors: Ilse M. Breedvelt-Schouten, Manotick (CA); Jana H. Jenkins, Raleigh, NC (US); Jeffrey A. Kusnitz, Campbell, CA (US)

(21) Appl. No.: 14/680,532

(22) Filed: Apr. 7, 2015

(51) Int. Cl. G06F 3/01; G06K 9/00; G06F 3/03

(52) U.S. Cl. CPC G06F 3/013; G06F 3/0304; G06K 9/0061

(57) ABSTRACT

In an approach to retrieving focus-based information, one or more computer processors receive a period of focused attention by a user on a user interface of a first device. The one or more computer processors determine one or more topics and one or more locations of the one or more topics based, at least in part, on the period of focused attention. The one or more computer processors store the one or more topics and the one or more locations of the one or more topics. The one or more computer processors determine whether the period of focused attention ends. Responsive to determining the period of focused attention ends, the one or more computer processors retrieve the one or more locations. The one or more computer processors display an indicator of the one or more locations.

### BACKGROUND OF THE INVENTION

The present invention relates generally to the field of computer user interface technology, and more particularly to retrieving focus-based information.

Eye tracking is the process of measuring either the point of gaze (where one is looking) or the motion of an eye relative to the head. An eye tracker is a device for measuring eye positions and eye movement. Eye trackers are used in research on the human visual system, in psychology, in cognitive linguistics, in marketing, as an input device for human computer interaction, and in product design. Eye trackers may be incorporated into a variety of user devices, including televisions, computers, mobile devices, and tablet computers. Eye tracking may be used to facilitate analysis of user viewing patterns. User viewing patterns can be monitored in certain architectures and tracked to identify preferred categories of content, interests, and the like.

### SUMMARY

Embodiments of the present invention disclose a method, a computer program product, and a system for retrieving focus-based information. The method may include one or more computer processors receiving a period of focused attention by a user on a user interface of a first device. The one or more computer processors determine one or more topics and one or more locations of the one or more topics based, at least in part, on the period of focused attention. The one or more computer processors store the one or more topics and the one or more locations of the one or more topics. The one or more computer processors determine whether the period of focused attention ends. Responsive to determining the period of focused attention ends, the one or more computer processors retrieve the one or more locations. The one or more computer processors display an indicator of the one or more locations.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a viewing history program, on a server computer within the distributed data processing environment of FIG. 1, for recording a user's viewing history and presenting the history to the user, in accordance with an embodiment of the present invention;

FIGS. 3A through 3C illustrate an example of the use of the viewing history program, via a user interface, on a client computing device within the distributed data processing environment of FIG. 1, in accordance with an embodiment of the present invention; and

FIG. 4 depicts a block diagram of components of the server computer executing the viewing history program within the distributed data processing environment of FIG. 1, in accordance with an embodiment of the present invention.

### DETAILED DESCRIPTION

Often a user is interrupted or distracted while reading, working, or viewing content on a computer or mobile device. Once distracted, the user may lose a previous train of thought or have difficulty remembering what the user was viewing at the time of the interruption. Embodiments of the present invention recognize that efficiency may be gained by presenting a user with a viewing history that enables the user to interact with and return to a previous viewing location following an end to a period of focused attention by retrieving focus-based information, based on eye tracking data or information. Implementation of embodiments of the invention may take a variety of forms, and exemplary implementation details are discussed subsequently with reference to the Figures.

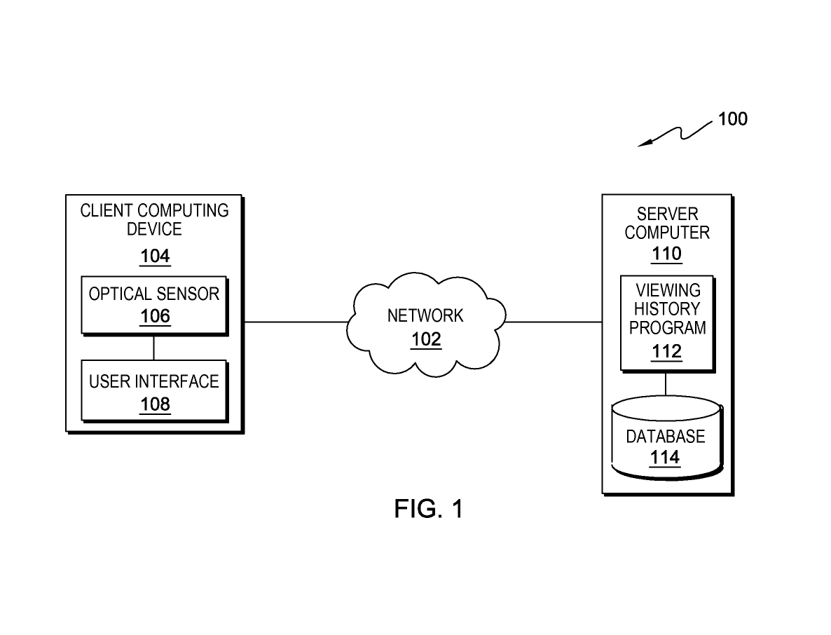

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 110, both interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between client computing device 104, server computer 110, and other computing devices (not shown) within distributed data processing environment 100.

Client computing device 104 can be a desktop computer, a laptop computer, a tablet computer, a specialized computer server, a smart phone, or any programmable electronic device capable of communicating with various components and devices within distributed data processing environment 100, via network 102. Client computing device 104 can be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In general, client computing device 104 represents any programmable electronic device or combination of programmable electronic devices capable of executing machine readable program instructions and communicating with other computing devices (not shown) within distributed data processing environment 100 via a network, such as network 102. Client computing device 104 includes optical sensor 106 and user interface 108.

Optical sensor 106 enables eye tracking of a user of client computing device 104. Generally, eye tracking uses a non-contact, optical method for measuring eye motion. Optical sensor 106 senses light, typically infrared, reflected from the user's eye. Optical sensor 106 may be a video camera or some other specially designed device that senses light. Optical sensor 106 may include eye tracking software that analyzes the reflected light to extract eye rotation from changes in reflections. Video-based eye trackers, such as may be used in embodiments of the present invention, typically use corneal reflection and the center of a pupil as features to track over time.

User interface 108 provides an interface between a user of client computing device 104 and server computer 110. User interface 108 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 108 may also be mobile application software that provides an interface between a user of client computing device 104 and server computer 110. Mobile application software, or an “app,” is a computer program designed to run on smart phones, tablet computers and other mobile devices. User interface 108 enables a user of client computing device 104 to receive an indicator of one or more previous viewing locations and a summary of viewing history from viewing history program 112. User interface 108 also enables a user to define preferences for viewing history program 112.

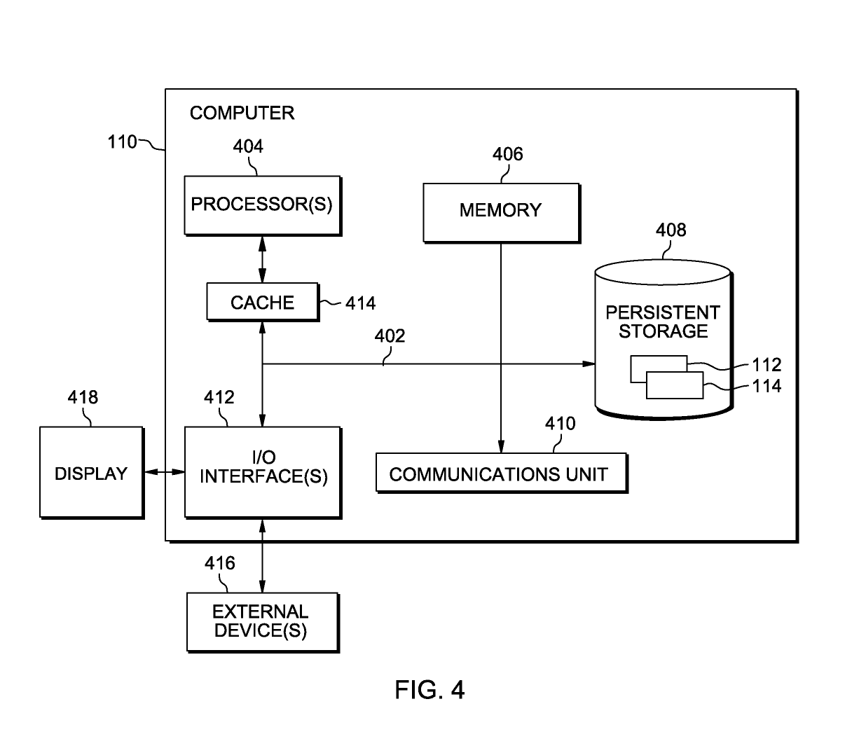

Server computer 110 can be a standalone computing device, a management server, a web server, a mobile computing device, or any other electronic device or computing system capable of receiving, sending, and processing data. In other embodiments, server computer 110 can represent a server computing system utilizing multiple computers as a server system, such as in a cloud computing environment. In another embodiment, server computer 110 can be a laptop computer, a tablet computer, a netbook computer, a personal computer (PC), a desktop computer, a personal digital assistant (PDA), a smart phone, or any programmable electronic device capable of communicating with client computing device 104 and other computing devices (not shown) within distributed data processing environment 100 via network 102. In another embodiment, server computer 110 represents a computing system utilizing clustered computers and components (e.g., database server computers, application server computers, etc.) that act as a single pool of seamless resources when accessed within distributed data processing environment 100. Server computer 110 includes viewing history program 112 and database 114. Server computer 110 may include internal and external hardware components, as depicted and described in further detail with respect to FIG. 4.

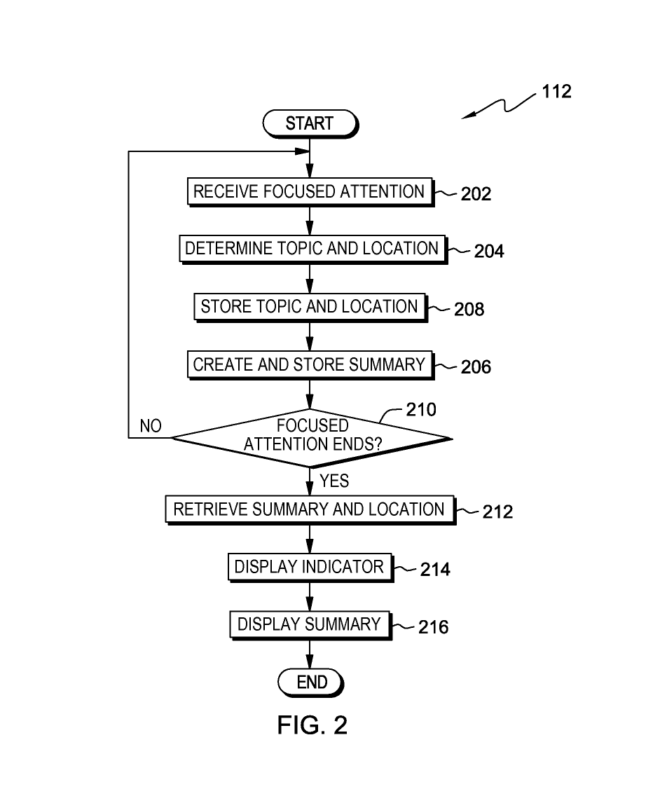

Viewing history program 112 creates an interactive summary of focus-based information, viewed by a user of client computing device 104. Viewing history program 112 resides on server computer 110. In another embodiment, viewing history program 112 can reside on client computing device 104 or elsewhere in the environment. Viewing history program 112 uses eye tracking data, or information, from optical sensor 106 to determine patterns of focused attention on a display or screen of a computing device, such as client computing device 104 by comparing the user's detected gaze to one or more pre-defined thresholds. A threshold may be defined based on a quantity of material a user views or reads, or a period of time a user spends viewing or reading. Viewing history program 112 determines that the patterns of focused attention indicate the location a user is viewing. After a period of focused attention ends, such as due to an interruption, viewing history program 112 utilizes the patterns to provide an indication to a user of previously viewed topics and a location on the screen at which the user arrived just before the period of focused attention ended. In one embodiment, a user defines preferences, via user interface 108, prior to using viewing history program 112 for the first time. In another embodiment, a user defines preferences, via user interface 108, at any time, whether viewing history program 112 is active or offline. For example, a user may indicate that viewing history program 112 should only capture viewing history from specific applications. In another example, if client computing device 104 is equipped with global positioning system (GPS) technology, a user may indicate, via user interface 108, that viewing history program 112 should only capture viewing history when client computing device 104 is located at the user's home or other specified location. Viewing history program 112 is depicted and described in further detail with respect to FIG. 2.

Database 114 resides on server computer 110. In another embodiment, database 114 can reside on client computing device 104 or elsewhere in the environment. A database is an organized collection of data. Database 114 can be implemented with any type of storage device capable of storing data and configuration files that can be accessed and utilized by server computer 110, such as a database server, a hard disk drive, or a flash memory. In other embodiments, database 114 can represent multiple storage devices within server computer 110. Database 114 stores information regarding a user's viewing history, as tracked by viewing history program 112. For example, database 114 may store a location in a document where the user was reading or a uniform resource locator (URL) of a website the user was browsing. Database 114 also stores a summary of a user's viewing history. Database 114 may also store user preferences for viewing history program 112.

FIG. 2 is a flowchart depicting operational steps of viewing history program 112, on server computer 110 within distributed data processing environment 100 of FIG. 1, for recording a user's viewing history and presenting the history to the user, in accordance with an embodiment of the present invention.

Viewing history program 112 receives a period of focused attention (step 202). Viewing history program 112 receives eye tracking data from optical sensor 106 that indicates that the user of client computing device 104 has been focused on information displayed on client computing device 104. In an embodiment, a threshold for determining whether attention is focused is defined and stored in database 114. For example, the threshold may be defined such that when a user reads a particular number of lines of text, the threshold is reached, and the reading is considered focused attention. In another example, the threshold may be defined such that when a user watches a video for a particular duration of time, the threshold is reached, and the viewing is considered focused attention. In one embodiment, a system designer pre-defines one or more thresholds as system defaults. In another embodiment, a user may define preferences that include one or more thresholds. In one embodiment, focused attention may be determined based on the presence of an audio clip playing on client computing device 104 for a pre-defined threshold period of time with no other user interactions.

Viewing history program 112 determines topic and location (step 204). By taking into account the location of the user's gaze, based on the eye tracking data, viewing history program 112 determines the topic and location of the user's focused attention. The topic may be, for example, the title of a document, a blog, a review, or an article. In another example, the topic may be a category used in a search engine. In a further example, the topic may be the subject of an email. The location may be, for example, an address of a document stored within client computing device 104 that the user was reading. In another example, the location may also be the spot on the screen where the user stopped reading. In a further example, the location may also be the URL of a website the user was viewing. In yet another example, the location may be point or phrase within a news feed the user is reading.

Viewing history program 112 stores topic and location (step 206). Viewing history program 112 stores the topic of the focused attention in database 114. Viewing history program 112 also stores the location of the focused attention in database 114.

Viewing history program 112 creates and stores a summary (step 208). Viewing history program 112 creates a summary of the focused attention. The summary includes data indicative of the topics and locations stored with respect to step 206. The summary may include a list of topics the user focused on, as discussed with respect to step 206. The summary may also include the location of the topics, as discussed with respect to step 206. The summary may indicate a date and/or time the focused attention occurred. The range of activity included in the summary may be defined as a user preference. For example, a user may specify that any summary that viewing history program 112 produces includes information from the last three hours or the last three days that viewing history program 112 received focused attention of the user. Viewing history program 112 stores the summary in database 114.

Viewing history program 112 determines whether a period of focused attention ends (decision block 210). In an embodiment, a threshold for determining whether a period of focused attention ends is defined and stored in database 114. For example, the threshold may be defined as a period of time that no eye tracking is detected, i.e., the user is not looking at client computing device 104. In another example, the threshold may be defined as any time client computing device 104 is powered off. In one embodiment, a system designer pre-defines one or more thresholds as system defaults. In another embodiment, a user may define preferences that include one or more thresholds. In one embodiment, the end of a period of focused attention may occur while the user continues to view client computing device 104. For example, a user may be reading an article on a website when the user receives a notification that an email has arrived. If the user leaves the article for a pre-defined period of time to read the email, even while optical sensor 106 continues to detect eye movement, the period of time may be defined as an end of a period of focused attention. In another example, a user may be reading an article on a website when the user receives a phone call. The user may or may not continue to view client computing device 104 while talking on the phone, but, due to a lack of focused attention, the period of time the user talks on the phone may be defined as an end of a period of focused attention. If viewing history program 112 determines a period of focused attention does not end (“no” branch, decision block 210), then viewing history program 112 returns to step 202 to receive additional focused attention.

If viewing history program 112 determines a period of focused attention ends (“yes” branch, decision block 210), then viewing history program 112 retrieves the summary and location (step 212). Viewing history program 112 retrieves, from database 114, the summary of topics and the location at which the user arrived just before the period of focused attention ended.

Viewing history program 112 displays an indicator (step 214). When the period of focused attention resumes, i.e., a user's gaze returns to client computing device 104 and optical sensor 106 detects the user's gaze, viewing history program 112 displays an indicator of the retrieved location at which the user arrived just before the end of the period of focused attention. For example, viewing history program 112 may display an arrow pointing to text the user was reading or a link to a video the user was viewing. In another example, viewing history program 112 may highlight a paragraph that the user was reading just before an interruption occurred. Highlighting may include changing the color or font of the text, flashing the text, or placing a box around the text. In one embodiment, when the period of focused attention resumes, viewing history program 112 may re-initiate a document the user was viewing and place a cursor at the position the user stopped reading. For example, if a user was reading a news feed on a website, viewing history program 112 may return the user to the location in the news feed at which the user had stopped reading just before the website was closed.

Viewing history program 112 displays the summary (step 216). Viewing history program 112 displays the retrieved summary of viewing history. In one embodiment, the displayed summary is interactive, where one or more items listed in the summary is an interactive link. For example, when the user clicks on an interactive link to an item or topic in the summary, viewing history program 112 can retrieve the location associated with the topic and display the previously viewed information to the user. The retrieved location may be a different location in the same document or website the user is currently viewing, or the retrieved location may be something the user focused on in the past, depending on the pre-defined threshold for focused attention. In one embodiment, a user defines preferences for displayed summaries via user interface 108. For example, a user may define the level of detail for viewing history program 112 to display in the summary. In another example, a user may use a mouse right-click menu on an item in the summary to indicate that viewing history program 112 should not display a particular type of item in the summary in the future. In one embodiment, viewing history program 112 may display the summary by date. For example, viewing history program 112 may list the days of the week or dates on a calendar, such that if a user knows the user read an interesting article on Monday, but does not remember on which website the article was published, the user can click on “Monday” in the summary, and viewing history program 112 lists the topics and locations stored in database 114 on Monday. In one embodiment, viewing history program 112 displays the summary by sending the summary to the user via an email or text message, such that the user can refer to the summary at a later time or date.

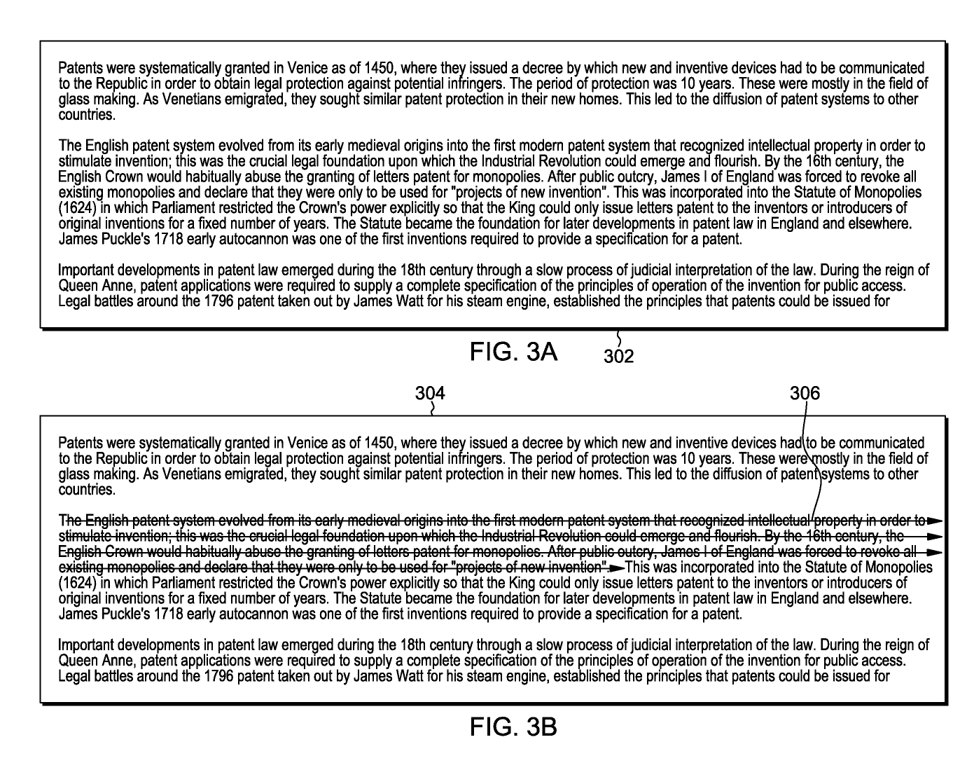

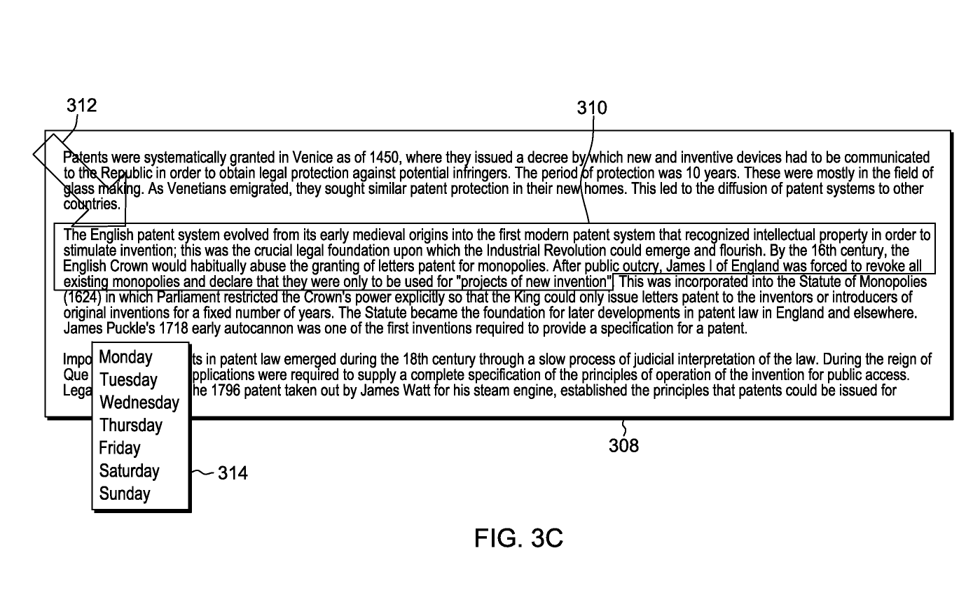

FIGS. 3A through 3C illustrate an example of the use of viewing history program 112, via user interface 108, on client computing device 104 within distributed data processing environment 100 of FIG. 1, in accordance with an embodiment of the present invention.

FIG. 3A depicts box 302 which includes several paragraphs from a text document as displayed on client computing device 104. FIG. 3B depicts box 304 which includes the same paragraphs from the same document depicted in box 302. Arrows 306 represent the left to right motion of a user's eyes as the user reads the first three sentences of the second paragraph. The user's reading of the sentences highlighted by arrows 306 is focused attention detected by optical sensor 106. Viewing history program 112 receives the focused attention, as discussed with respect to FIG. 2, and determines the location of the user's gaze via eye tracking data.

FIG. 3C depicts box 308 which also includes the same paragraphs from the same document depicted in boxes 302 and 304. Box 310 surrounds the text that the user read just before the end of a period of focused attention. Viewing history program 112 displays the text in box 310 with an indicator that the text is the location at which the user may have been interrupted. Within box 310, viewing history program 112 can, for example, change the color or font of the text, or display the text flashing, or provide additional highlighting to indicate the location of the text. Arrow 312 is another example of a method viewing history program 112 may use to indicate the user's previous focused attention. Box 314 is an example of an interactive summary displayed by viewing history program 112. In the example, the user has defined a preference for the summary to be organized by day of the week. The user may click on one of the days, and viewing history program 112 displays a list of topics and locations the user had viewed on the chosen day.

FIG. 4 depicts a block diagram of components of server computer 110 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 110 includes processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., viewing history program 112 and database 114 are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 104. In these examples, communications unit 410 includes one or more network interface cards. Communications unit 410 may provide communications through the use of either or both physical and wireless communications links. Viewing history program 112 and database 114 may be downloaded to persistent storage 408 through communications unit 410.

I/O interface(s) 412 allows for input and output of data with other devices that may be connected to server computer 110. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., viewing history program 112 and database 114, can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor. Display 418 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for retrieving focus-based information, the method comprising:
receiving, by one or more computer processors, a period of focused attention by a user on a user interface of a first device;
determining, by the one or more computer processors, one or more topics and one or more locations of the one or more topics based, at least in part, on the period of focused attention;
storing, by the one or more computer processors, the one or more topics and the one or more locations of the one or more topics;
determining, by the one or more computer processors, whether the period of focused attention ends;
responsive to determining the period of focused attention ends, retrieving, by the one or more computer processors, the one or more locations; and
displaying, by the one or more computer processors, an indicator of the one or more locations.

2. The method of claim 1, further comprising:
creating, by the one or more computer processors, a summary, wherein the summary includes data indicative of the one or more topics and one or more locations; and
displaying, by the one or more computer processors, the summary.

3. The method of claim 2, wherein the summary includes one or more interactive links to one or more stored locations.

4. The method of claim 1, wherein receiving a period of focused attention further comprises receiving, by the one or more computer processors, eye tracking information from an optical sensor on the first device, wherein the eye tracking information indicates a pre-defined threshold is reached.

5. The method of claim 4, wherein the pre-defined threshold includes at least one of: a quantity of material a user views, and a period of time a user spends viewing.

6. The method of claim 4, wherein the optical sensor includes one or more cameras.

7. The method of claim 1, wherein the indicator includes one or more of: a change of text color, a change of text font type, flashing text, an arrow, a location of a cursor, and a box surrounding a location on a screen.

8. The method of claim 1, wherein determining the period of focused attention ends further comprises determining, by the one or more computer processors, a pre-defined threshold of time is reached during which no focused attention is received.

9. A computer program product for retrieving focus-based information, the computer program product comprising:
one or more computer readable storage device and program instructions stored on the one or more computer readable storage device, the program instructions comprising:
program instructions to receive a period of focused attention by a user on a user interface of a first device;
program instructions to determine one or more topics and one or more locations of the one or more topics based, at least in part, on the period of focused attention;
program instructions to store the one or more topics and the one or more locations of the one or more topics;
program instructions to determine whether the period of focused attention ends;
responsive to determining the period of focused attention ends, program instructions to retrieve the one or more locations; and
program instructions to display an indicator of the one or more locations.

10. The computer program product of claim 9, further comprising:
program instructions to create a summary, wherein the summary includes data indicative of the one or more topics and one or more locations; and
program instructions to display the summary.

11. The computer program product of claim 9, wherein receiving a period of focused attention further comprises program instructions to receive eye tracking information from an optical sensor on the first device, wherein the eye tracking information indicates a pre-defined threshold is reached.

12. The computer program product of claim 11, wherein the pre-defined threshold includes at least one of: a quantity of material a user views, and a period of time a user spends viewing.

13. The computer program product of claim 9, wherein the indicator includes one or more of: a change of text color, a change of text font type, flashing text, an arrow, a location of a cursor, and a box surrounding a location on a screen.

14. The computer program product of claim 9, wherein program instructions to determine the period of focused attention ends further comprises program instructions to determine a pre-defined threshold of time is reached during which no focused attention is received.

15. A computer system for retrieving focus-based information, the computer system comprising:
one or more computer processors;
one or more computer readable storage device;
program instructions stored on the one or more computer readable storage device for execution by at least one of the one or more computer processors, the program instructions comprising:
program instructions to receive a period of focused attention by a user on a user interface of a first device;
program instructions to determine one or more topics and one or more locations of the one or more topics based, at least in part, on the period of focused attention;
program instructions to store the one or more topics and the one or more locations of the one or more topics;
program instructions to determine whether the period of focused attention ends;
responsive to determining the period of focused attention ends, program instructions to retrieve the one or more locations; and
program instructions to display an indicator of the one or more locations.

16. The computer system of claim 15, further comprising:
program instructions to create a summary, wherein the summary includes data indicative of the one or more topics and one or more locations; and
program instructions to display the summary.

17. The computer system of claim 15, wherein receiving a period of focused attention further comprises program instructions to receive eye tracking information from an optical sensor on the first device, wherein the eye tracking information indicates a pre-defined threshold is reached.

18. The computer system of claim 17, wherein the pre-defined threshold includes at least one of: a quantity of material a user views, and a period of time a user spends viewing.

19. The computer system of claim 15, wherein the indicator includes one or more of: a change of text color, a change of text font type, flashing text, an arrow, a location of a cursor, and a box surrounding a location on a screen.

20. The computer system of claim 15, wherein program instructions to determine the period of focused attention ends further comprises program instructions to determine a pre-defined threshold of time is reached during which no focused attention is received.
